(19) United States
(12) Patent Application Publication
(10) Pub. No.: US 2006/0060788 A1
(43) Pub. Date: Mar. 23, 2006

(54) Infrared sensor, infrared gas detector and infrared ray source

(75) Inventors: Koji Uchida, Kariya-city (JP); Masaaki Tanaka, Kariya-city (JP); Takahiko Yoshida, Okazaki-city (JP)

Correspondence Address: POSZ LAW GROUP, PLC, 12040 SOUTH LAKES DRIVE, SUITE 101, RESTON, VA, 20191, US

(73) Assignees: DENSO CORPORATION; NIPPON SOKEN, INC.

(21) Appl. No.: 11/178,380

(22) Filed: Jul. 12, 2005

(30) Foreign Application Priority Data
Sep. 6, 2004 (JP) 2004-258669

(51) Int. Cl. G01J 5/02

(52) U.S. Cl. 250/343

(57) ABSTRACT

An infrared sensor includes a substrate, a membrane as a small-thickness portion formed on the substrate, a detecting element for generating a detection signal on the basis of temperature variation occurring when receiving infrared rays, at least a part thereof being formed on the membrane, and an infrared ray absorption film formed on the membrane so as to cover at least a part of the detecting element. The detecting element is externally electrically connected through a sensor pad portion provided at an end portion of the detecting element. A substrate surface including the sensor pad portion and the infrared ray absorption film is coated by a protection film made of parylene.

### CROSS REFERENCE TO RELATED APPLICATION

This application is based upon, claims the benefit of priority of, and incorporates by reference the contents of Japanese Patent Application No. 2004-258669 filed on Sep. 6, 2004.

### FIELD OF THE INVENTION

The present invention relates to an infrared sensor for detecting infrared rays, an infrared gas detector containing the infrared sensor for detecting the concentration of measurement target gas by using infrared rays, and an infrared light ray source for irradiating infrared rays to the infrared sensor.

### BACKGROUND OF THE INVENTION

For example, JP-A-2003-270047 discloses an infrared sensor having a detecting element for generating a detection signal on the basis of temperature variation occurring when the detecting device detects infrared rays. According to the infrared sensor disclosed in the above publication, a sensor element (detecting element) is air-tightly sealed by a stem and a cap having an opening portion closed by a filter through which infrared rays are selectively transmissible. When the infrared sensor is designed in a so-called can sealing structure as described above, an electrode (pad portion) provided at the end portion of the detecting element can be prevented from being corroded.

However, in the case of the above structure, the detecting element is sealed by the stem and the cap, and thus it is difficult to miniaturize the body of the infrared sensor.

Furthermore, there may be considered such a construction that the pad portion of the detecting element is protected by applying gel (for example, silicon gel) as protection film. It is difficult to protect only the pad portion by gel because of the characteristic (viscosity) of the gel, and thus not only the pad portion, but also the upper surface of the detecting element (that is, one surface on which the detecting element is formed) is generally protected. However, gel (particularly, silicon gel) has low transmittance to infrared rays and thus the light receiving efficiency of the infrared sensor is lowered (that is, the sensor sensitivity is lowered). Furthermore, the infrared sensor may be designed so that a dam is provided to protect only the pad portion by gel. However, in this case, it is necessary to provide a dam and thus it is difficult to miniaturize the sensor body.

The same problem as described above also occurs in an infrared gas detector having the infrared sensor or an infrared ray source for irradiating infrared rays to the infrared ray sensor.

### SUMMARY OF THE INVENTION

In view of the foregoing problem, it is an object to provide an infrared sensor, an infrared gas detector and an infrared ray source in which the body can be miniaturized and the light receiving efficiency of the infrared sensor can be enhanced more than a case where gel is applied as protection film.

In order to attain the above object, an infrared sensor includes a substrate, a membrane as a small-thickness portion formed on the substrate, a detecting element for generating a detection signal on the basis of temperature variation occurring when receiving infrared rays, at least a part thereof being formed on the membrane, and infrared ray absorption film formed on the membrane so as to cover at least a part of the detecting element.

According to a first aspect, under the state that the detecting element is electrically externally connected through a sensor pad portion provided to the end portion of the detecting element, a substrate surface containing the sensor pad portion and the infrared ray absorption film is coated by protection film formed of parylene.

It has been found by the inventor of this application that parylene, which is excellent in electrical insulation, prevention of transmission of water vapor and various kinds of gas, etc. has higher transmittance to infrared rays than gel such as silicon or the like. That is, by applying parylene as protection film, the whole surface at one surface side of the substrate surface containing not only the sensor part portion, but also the infrared ray absorption film can be protected. Accordingly, the body can be miniaturized, and the light receiving efficiency of the infrared sensor can be enhanced more than when gel is applied as protection film. Furthermore, the construction can be simplified.

Furthermore, at least the cap is unnecessary, and thus the angle of visual field of the infrared sensor is not restricted, so that the light receiving efficiency of the infrared sensor can be enhanced.

Furthermore, the detecting element is designed so as to be thermally separated from the substrate, and thus the sensor output of the infrared sensor can be increased.

Parylene is a brand name of polyparaxylelene resin developed by Union Carbide Company of U.S.A., and parylene N (polyparaxylelene), parylene C (polymonochloro paraxylelene) or parylene D (polydichloro paraxylelene) is generally known.

The detecting element may be a thermocouple having a hot contact point formed on the membrane and a cold contact point formed on the substrate excluding the formation area of the membrane.

Furthermore, when the substrate is a semiconductor substrate and the detecting element is formed on the semiconductor substrate through insulating film, the substrate having the membrane can be easily formed by a general semiconductor process. That is, the construction can be simplified, and an infrared sensor having high sensitivity can be manufactured at low cost.

Parylene C is particularly excellent in penetration preventing performance of water vapor and various kinds of gas. Accordingly, by applying parylene C as protection film, the corrosion of the sensor pad portion can be more effectively prevented.

According to a second aspect, there is provided an infrared gas detector for detecting the concentration of measurement target gas, characterized by including the above infrared sensor and an infrared ray source for radiating infrared rays to the infrared ray sensor by heating a resistor, the infrared sensor and the infrared ray source being mounted in the same package.

It has been hitherto generally known that a filter for selectively transmitting infrared rays (infrared rays having an absorption characteristic to the measurement target gas) is disposed at an opening portion provided on the upper surface of a cap for can-sealing an infrared sensor so as to close the opening portion. However, in the present infrared gas detector, when parylene is applied as protection film of the infrared sensor, the can-sealing structure of the infrared sensor portion is not required. In this case, an infrared-ray transmissible wavelength selecting element for irradiating infrared ray having a specific wavelength to the infrared sensor may be provided.

Furthermore, when there is further provided a reference infrared sensor for absorbing infrared ray having a specific wavelength non-overlapped with the infrared-ray absorption wavelength of the measurement target gas and outputting a reference signal in accordance with the infrared-ray absorption amount, the infrared-ray transmissible wavelength selecting element may be designed so as to irradiate infrared rays having specific wavelengths to the infrared sensor and the reference infrared sensor. Specifically, a diffraction grating (multiple slit) is applicable. In addition, the infrared-ray transmissible wavelength selecting element for irradiating infrared rays having specific wavelengths to the infrared sensor and the reference infrared sensor may be designed by laminating filters for transmitting infrared rays having the specific wavelengths therethrough.

Furthermore, according to a third aspect, there is provided an infrared ray source for irradiating infrared rays to an infrared sensor that comprises a substrate, a membrane as a small-thickness portion provided to the substrate and a resistor provided to the membrane and heats the resistor by supplying current to the resistor to detect the infrared rays.

Under the state that the resistor is electrically connected to the outside through an infrared ray source pad portion provided to the end portion of the resistor, the substrate surface containing the infrared ray source pad portion is coated by protection film formed of parylene.

In the conventional infrared ray source having the above construction (solely or infrared gas detector), corrosion of the infrared ray source pad portion is prevented by applying the can-sealing structure as in the case of the infrared sensor described above. However, if parylene is applied as protection film, the whole surface at one surface side of the substrate surface containing not only the light source portion, but also the formation area on which the resistor is formed can be protected by the same action and effect as the first aspect. Accordingly, the can-sealing structure is not required, and thus the body can be miniaturized, so that the construction can be simplified. Furthermore, the energy amount of infrared ray transmitted through the protection film is larger than when gel is applied as protection film, and thus the light receiving efficiency of the infrared sensor can be enhanced.

Furthermore, the resistor is designed to be thermally separated form the substrate, so that the infrared ray source can efficiently emit infrared rays, and the sensor output of the infrared sensor can be increased.

When the substrate is a semiconductor substrate and the resistor is formed on the semiconductor substrate through insulating film, the substrate having the membrane can be easily formed by a general semiconductor process. That is, the construction can be simplified, and the infrared ray source excellent in infrared-ray emission efficiency can be manufactured at low cost.

### BRIEF DESCRIPTION OF THE DRAWINGS

FIG. 1A is a plan view showing the schematic construction of an infrared sensor according to a first embodiment, and FIG. 1B is a cross-sectional view taken along IB-IB of FIG. 1A;

FIG. 2 is a diagram showing effects of the second protection film;

FIG. 3 is a schematic diagram showing the construction of an infrared gas detector according to a second embodiment;

FIG. 4 is a schematic diagram showing the construction of an infrared gas detector according to a third embodiment;

FIG. 5 is a diagram showing a modification of an infrared ray source; and

FIG. 6A is a plan view showing the construction of an infrared ray source according to a fourth embodiment, and FIG. 6B is a cross-sectional view taken along VIB-VIB of FIG. 6A.

### DETAILED DESCRIPTION OF THE PREFERRED EMBODIMENTS

Preferred embodiments according will be described hereunder with reference to the accompanying drawings.

### First Embodiment

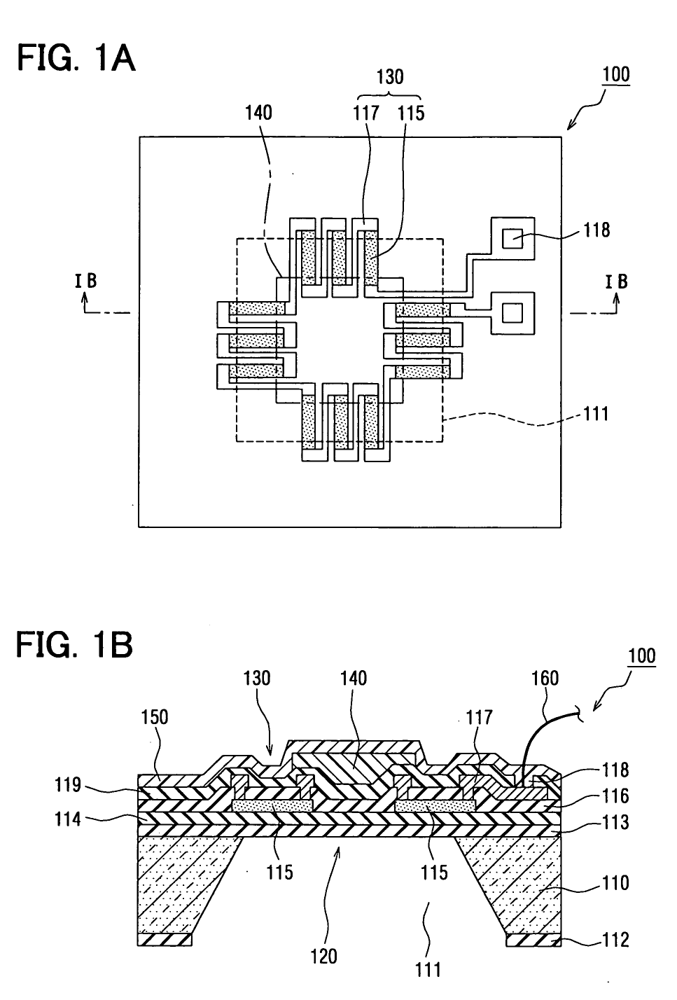

FIGS. 1A and 1B are diagrams showing the schematic construction of an infrared sensor according to a first embodiment, wherein FIG. 1A is a plan view and FIG. 1 B is a cross-sectional view taken along IB-IB of FIG. 1A. In FIG. 1A, a detecting element and a wire portion for connecting the detecting element and electrodes are illustrated for the sake of convenience. A rectangular area surrounded by a broken line represents a formation area on the upper surface of a cavity portion on the upper surface of the substrate, and a rectangular surrounded by a one-dotted chain line represents a formation area of infrared ray absorption film.

As shown in FIG. 1B, an infrared sensor 100 has a substrate 110, a membrane 120 as a small-thickness portion provided to the substrate 110, a detecting element 130 for detecting infrared rays, infrared-ray absorption film 140, and a second protection film 150 formed of parylene. The second protection film 150 is a feature portion of this embodiment, and it corresponds to protection film of the present invention.

The substrate 110 is a semiconductor substrate formed of silicon, and has a cavity portion 111 corresponding to the formation area of the membrane 120. In this embodiment, the cavity portion 111 is opened so as to have a rectangular area, and the area of the opening portion is reduced toward the upper surface side of the substrate 110, and a rectangular area indicated by a broken line in FIG. 1A is formed on the upper surface of the substrate 110. Accordingly, the membrane 120 containing the detecting element 130 is formed so as to be floated above the cavity portion 111 with respect to the substrate 110, and the film thickness at this site is set to be smaller than the other sites of the infrared sensor 100.

As described above, when the substrate 110 is a semiconductor substrate, the membrane 120 can be easily formed on the substrate 110 by the general semiconductor process. That is, a high-sensitivity infrared sensor 100 can be manufactured at low cost. In place of the semiconductor substrate, a glass substrate or the like may be applied as the substrate 110.

Silicon nitride film 112 is provided on the lower surface of the substrate 110, and insulating film 113 (for example, silicon nitride film) is provided on the upper surface of the substrate 110. Furthermore, silicon oxide film 114 is provided on the insulating film 113 concerned.

Polycrystalline silicon film 115 is provided on the silicon oxide film 114. The polycrystalline silicon film 115 is provided so as to extend from the membrane 120 to a large-thickness site of the substrate 110 which is located within a predetermined range from the membrane 120 at the outside of the membrane 120, and it is patterned in a predetermined shape so as to constitute a part of the detecting element 130. In FIG. 1A, the polycrystalline silicon film 115 is hatched to discriminate it from the other parts.

A wire portion 117 formed of aluminum is connected through interlayer insulating film 116 formed of BPSG (Boron-doped Phospho-Silicate Glass) on the polycrystalline silicon film 115. The wire portion 117 connects both the end portion of each polycrystalline silicon film 115 through contact holes formed in the interlayer insulating film 116, and constitutes a thermocouple serving as the detecting element 130 together with the polycrystalline silicon film 115, and also connects the detecting element 130 to electrodes.

Here, as shown in FIG. 1A, the thermocouple serving as the detecting element 130 is formed by alternately arranging plural pairs of the polycrystalline silicon film 115 and the wire portion 117 in series (thermopile), and every other joint portion serves as a hot contact point formed on the membrane 120 having a small heat capacity while each of the other joint portions serves as a cold contact point formed on the substrate 110 having a large heat capacity outside the membrane 120. Accordingly, the substrate 110 serves as a heat sink.

At least a part of the detecting element 130 is formed on the membrane 120, and at least a part of the site of the detecting element 130 formed on the membrane 120 is coated by the infrared-ray absorption film 140. Any member may be applied as the detecting element 130 insofar as it generates an electrical signal on the basis of temperature variation occurring when it receives infrared rays. Accordingly, in place of the thermocouple, a bolometer type detecting element equipped with a resistor or a pyroelectric type detecting element equipped with a pyroelectric element may be used as the detecting element 130. Furthermore, the constituent materials of the thermocouple as the detecting element 130 are not limited to polycrystalline silicon film 115 and the wire portion 117 formed of aluminum.

The wire portion 117 has pad portions 118 as electrodes at the end portions thereof, and first protection film 119 (for example, silicon nitride film) is formed on the wire portion 117 excluding the pad portions 118.

The infrared-ray absorption film 140 is formed on the first protection film 119 in the formation area of the membrane 120 so as to cover at least a part of the detecting element 130. In FIG. 1A, a rectangular area surrounded by a one-dotted chain line represents a formation area of the infrared-ray absorption film 140.

The infrared-ray absorption film 140 of this embodiment is formed by doping polyester resin with carbon and fire-hardening it, and it is formed on the membrane 120 so as to cover the hot contact point so that the temperature of the hot contact point of the detecting element 130 is efficiently increased by absorbing the infrared rays. Furthermore, the infrared-ray absorption film 140 is formed so as to be spaced from the end of the formation area of the membrane 20 at a predetermined interval. The interval (the ratio between the width of the infrared-ray absorption film 140 and the width of the membrane 120), was disclosed by the applicant of this application in JP-A-2002-365140, the contents of which are incorporated herein by reference, and thus the description thereof is omitted from this embodiment.

Accordingly, the infrared ray having a specific wavelength emitted from the infrared ray source is absorbed by the infrared-ray absorption film 140 to increase the temperature. As a result, the temperature of the hot contact point of the detecting element 130 disposed below the infrared ray absorption film 140 is increased. On the other hand, the temperature increase of the cold contact point is relatively smaller because the substrate 110 serves as a heat sink. As described above, the detecting element 130 varies electromotive force thereof by the temperature difference occurring between the hot contact point and the cold contact point when infrared rays are received (Seebeck effect), and detects the intensity of the infrared rays (for example, the gas concentration) on the basis of the electromotive force thus varying. The thermocouple shown in FIG. 1A is a thermopile, and thus the total of electromotive force occurring by the pairs of the polycrystalline silicon film 115 and the wire portions 117 is equal to an output Vout of the detecting element 130.

Furthermore, in this embodiment, under the state that a bonding wire 160 for electrically externally connecting the pad portion 118 is connected to the pad portion 118, the second protection film 150 formed of parylene is provided on the whole surface containing the connection site concerned on the substrate 110 as shown in FIG. 1B. Parylene is a brand name of polyparaxylelene resin developed by Union Carbide Company of U.S.A., and parylene N (polyparaxylelene), parylene C (polymonochloro paraxylelene) or parylene D (polydichloro paraxylelene) is generally known.

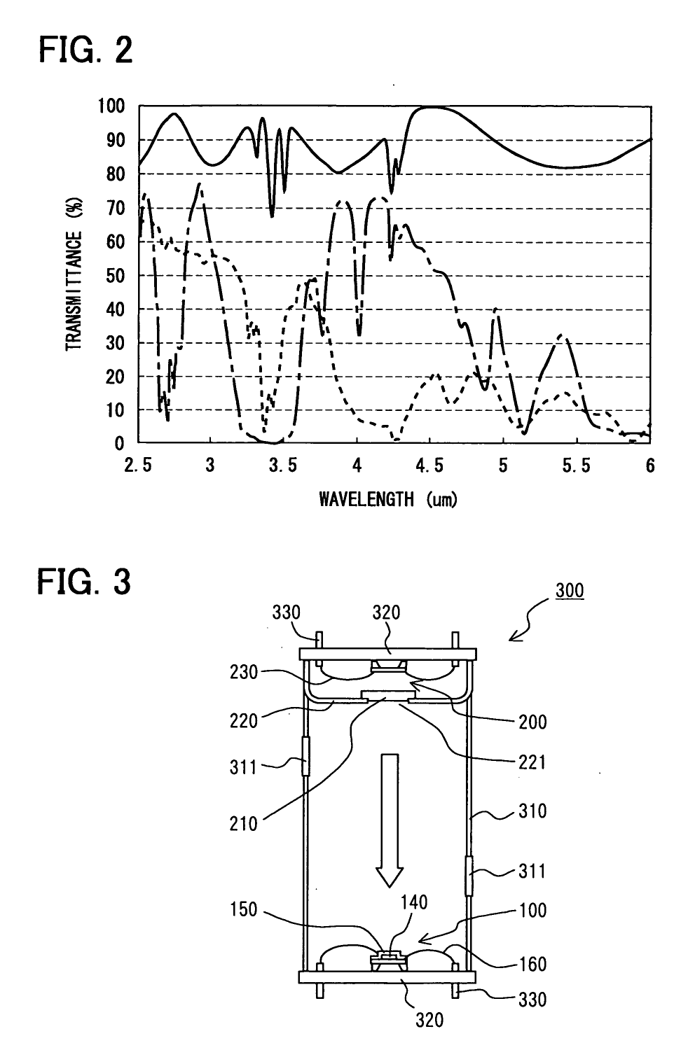

Through an examination carried out by the inventor of this application, it has been found that parylene which is excellent in electrical insulating performance, penetration preventing performance of water vapor and various kinds of gas, etc. has high infrared-ray transmittance than gel such as silicon or the like. The examination result is shown in FIG. 2. FIG. 2 is a diagram showing the effect of the second protection film 150. Parylene C (5 μm) was used as an example of parylene, and a comparison result with silicon gel (750 μm) and fluorine gel (600 μm) is shown in FIG. 2. In FIG. 2, a solid line represents parylene C, a broken line represents silicon gel and a one-dotted chain line represents fluorine gel. The film thickness of silicon gel and fluorine gel is set so that they can function as the second protection film 150.

By applying parylene as the second protection film 150 as described above, variation of electromotive force which is enough to detect infrared rays occurs in the infrared sensor 100 even when the infrared rays are incident through the second protection film 150 to the infrared-ray absorption film 140 because the infrared-ray transmittance of parylene is higher than gel such as silicon or the like. Accordingly, the second protection film 150 can be provided on the whole surface at one surface side of the substrate 110 containing the pad portion 118 and the infrared-ray absorption film 140.

Furthermore, the corrosion of the pad portion 118 can be prevented without utilizing the can-sealing structure, and thus the body of the sensor can be miniaturized. In addition, the construction of the sensor can be simplified, and at least a cap is unnecessary, so that the restriction of the visual field angle of the infrared sensor 100 (caused by the opening portion) is eliminated, so that the light receiving efficiency of the infrared sensor 100 can be enhanced.

Parylene C is particularly excellent in penetration preventing performance of water vapor and various kinds of gas among the parylene group. Accordingly, by applying parylene C as the second protection film 150, the corrosion of the pad portion 118 can be more effectively prevented.

Next, a method of forming the infrared sensor 100 thus constructed will be described with reference to FIG. 1B.

Insulating film 113 formed of silicon nitride is formed on the whole surface of the substrate 110 of silicon by the CVD method, for example. The insulating film 113 serves as an etching stopper when the substrate 110 is etched as described later. The insulating film 113 is an element constituting the membrane 120, and thus it is important to form the insulating film 113 while controlling the membrane stress. Therefore, it may be formed as composite film of silicon nitride film and silicon oxide film as occasion demands, for example.

Silicon oxide film 114 is formed so as to cover the insulating film 113 by the CVD method, for example. The silicon oxide film 114 enhances the adhesion to the polycrystalline silicon film 115 formed just above the silicon oxide film 114, and serves as an etching stopper when the polycrystalline silicon film 115 is etched.

Subsequently, the polycrystalline silicon film 115 is formed on the silicon oxide film 114 by the CVD method, for example, and doped with impurities such as phosphorous or the like so as to achieve a predetermined resistance value. It is patterned in a predetermined shape by a photolithographic treatment. At this time, silicon oxide film may be formed on the surface of the polycrystalline silicon film 115 by thermal oxidation (not shown). This polycrystalline silicon 115 serves as a part of the detecting element 130. The constituent material of the detecting element 130 is not limited to polycrystalline silicon, and monocrystal silicon doped with impurities, metal materials such as gold, platinum, etc. may be used as the constituent material.

After the polycrystalline silicon film 115 is formed, BPSG film serving as interlayer insulating film 116 is formed on the silicon oxide film 114 containing the polycrystalline silicon film 115 by the CVD method, and subjected to a heat treatment at a temperature of 900 to 1000° C., for example. When the BPSG film serving as the interlayer insulating film 116 is thermally treated at a high temperature as described above, the step portion at the end of the polycrystalline silicon film 115 is smoothened to thereby moderate the step shape. Accordingly, the insufficient coverage problem of the wire portion 117 can be solved. After the heat treatment, the interlayer insulating film 116 is subjected to the photolithography treatment to form contact holes for connection at the overlap position in the laminate direction between the polycrystalline silicon film 115 and the wire portion 117 in the formation area of the membrane 20. The interlayer insulating film 116 is not limited to the BPSG film, and silicon nitride film or silicon oxide film may be used or composite film of silicon oxide film and silicon nitride film may be used.

Aluminum of low-resistance metal material is formed in the contact hole and on the interlayer insulating film 116, and patterned by the photolithography treatment, thereby forming the wire portion 117 electrically connected to the polycrystalline silicon film 115. In addition to the formation of the wire portion 117, the pad portions 118 as the electrodes are formed at the end portions of the wire portion 117. The material constituting the wire portion 117 may be low-resistant metal such as gold, copper or the like in place of aluminum.

Here, the wire portion 117 connects the end portions of the polycrystalline silicon film 115 through the contact holes formed in the interlayer insulating film 116, and constitutes the detecting element 130 (thermocouple) together with the polycrystalline silicon film 115. Furthermore, it connects the detecting element 130 to the pad portions 118.

Subsequently, the first protection film 119 formed of silicon nitride is formed by the CVD method, for example, and patterned by the photolithography treatment to form opening portions at which the pad portions 118 will be formed, whereby the pad portions 118 provided to the end portions of the wire portion 117 are exposed from the first protection film 119.

After the formation of the first protection film 119, for example, paste of polyester resin doped with carbon is screen-printed on the first protection film 119 in the formation area of the membrane 120 so that the hot contact point of the detecting element 130 is coated with the paste. The film thus formed is fire-hardened to form the infrared-ray absorption film 140.

Under the state that the infrared-ray absorption film 140 is formed and the bonding wire 160 is connected to the pad portion 118, the second protection film 150 formed of parylene C is formed on the whole surface at one surface side of the substrate 110 containing the pad portion 118 and the infrared-ray absorption film 140 by the CVD method, for example. At this time, parylene N or parylene D may be applied as the second protection film 150 in place of parylene C.

Finally, silicon nitride film 112 serving as an etching mask is formed on the whole lower surface of the substrate 110 by the plasma CVD method, for example. Then, a cavity site corresponding to an area in which the membrane 120 is formed is formed in the silicon nitride film 112 by the photolithography treatment, and the substrate 110 of silicon is etched by an anisotropic etching treatment using potassium hydroxide aqueous solution, for example. In this etching treatment, the substrate 110 is etched until the insulating film 113 provided on the upper surface of the substrate 110 is exposed, and the membrane 120 is formed on the cavity portion 111 of the substrate 110 which is formed by the etching treatment. Through the above process, the infrared sensor 100 of this embodiment is formed.

The infrared sensor 100 of this embodiment can be formed by the general semiconductor process, and thus the manufacturing cost can be reduced. The infrared-ray absorption film 140 may be formed, not after the formation of the protection film 119, but after the formation of the cavity portion 111. In the above manufacturing process, when the film having moisture-absorption characteristics such as the silicon oxide film 114, etc. is formed, a heat treatment may be carried out after the film formation to prevent variation of the membrane stress due to moisture-absorption as occasion demands.

In this embodiment, the first protection film 119 is formed on the interlayer insulating film 116 containing the wire portion 117 to protect the wire portion 117 of aluminum. However, parylene excellent in the water-vapor penetration preventing performance is provided as the second protection film 150 on the whole surface at one surface side of the substrate 110 containing the pad portion 118 and the infrared-ray absorption film 140, and thus the first protection film 119 is not necessarily formed.

### Second Embodiment

Next, a second embodiment will be described with reference to FIG. 3. FIG. 3 is a diagram showing the schematic construction of an infrared gas detector according to this embodiment.

In the second embodiment, the infrared sensor 100 of the first embodiment is applied to a gas detector, and it has many common parts to the first embodiment. Therefore, the detailed description on the common parts is omitted from the following description, and different parts will be mainly described.

As shown in FIG. 3, the infrared sensor 100 of the first embodiment may constitute an infrared ray detection type gas detector 300 (hereinafter referred to as gas sensor) in combination with an infrared ray source 200 for radiating infrared rays to the infrared ray sensor 100.

In this case, the infrared sensor 100 has second protection film 150 on the surface thereof, and thus the can-sealing structure which has been hitherto required is unnecessary. Therefore, in this embodiment, an infrared-ray transmissible wavelength selecting element 210 for making infrared ray having a specific wavelength incident to the infrared sensor 100 is provided on the infrared ray source 200.

Specifically, the infrared sensor 100 and the infrared ray source 200 are fixed on tables 320 disposed at both the ends of a cylindrical container 310, and electrically connected through bonding wires 160 and 230 to leads 330 which penetrate through and are fixed to the tables 320. Furthermore, a cap 220 for restricting the radiation direction of infrared rays emitted isotopically from the infrared ray source 200 and air-tightly sealing the infrared ray source 200 with the table 320 is disposed at only the infrared ray source 200 side, and a band pass filter for selectively transmitting only infrared ray having a specific wavelength therethrough is disposed as the infrared-ray transmissible wavelength selecting element 210 so as to close an opening portion 221 formed in the upper surface of the cap 220 which confronts the infrared ray source 200. In FIG. 3, reference numeral 230 represents bonding wires for connecting the infrared ray source 200 to the leads 330, and reference numeral 311 represents plural gas inlet/outlet ports (two places in FIG. 3) provided to the container 310 so that gas containing measurement target gas can flow in through the gas inlet/outlet ports.

With the above construction, the gas sensor 300 has the infrared sensor 100 equipped with the second protection film 150, but does not have the infrared ray transmissible wavelength selecting element 210 at the infrared sensor 100 side, however, it transmits therethrough only infrared ray having a specific wavelength (an outline arrow in FIG. 3) out of infrared rays emitted from the infrared ray source 200 by the infrared-ray transmissible wavelength selecting element 210 disposed on the infrared ray source 200. The infrared ray thus transmitted is absorbed through the second protection film 150 by the infrared-ray absorption film 140. At this time, the intensity of the infrared ray reaching the infrared sensor 100 varies in accordance with the concentration of the measurement target gas, and thus the output of the infrared sensor 100 is also varied in accordance with the variation of the intensity of the infrared ray, so that the concentration of the measurement target gas can be detected.

Furthermore, with the construction of this embodiment, no cap is provided at the infrared sensor 100 side, and thus visual field angle of the infrared sensor 100 is not restricted by the cap, so that the light receiving efficiency of the infrared ray sensor 100 can be enhanced. Furthermore, no cap is provided at the infrared sensor 100 side, and thus the body of the gas sensor 300 can be miniaturized.

In this embodiment, the gas detector is designed as a linear type in which the infrared sensor 100 and the infrared ray source 200 are arranged so as to confront each other. However, it may be designed as a reflection type in which the infrared sensor 100 and the infrared ray source 200 are juxtaposed with each other. At this time, the infrared sensor 100 and the infrared ray source 200 may be formed on the same substrate.

In this embodiment, the infrared sensor 100 and the infrared ray source 200 are arranged in the space comprising the same container 310 and the tables 320, however, they are not necessarily required to be disposed in the space comprising the same containers 310 and the tables 320. However, when the infrared sensor 100 and the infrared ray source 200 are disposed in the space comprising the same container 310 and the tables 320, the positional relationship between the infrared sensor 100 and the infrared ray source 200 is easily determined.

Furthermore, in this embodiment, the band pass filter is applied as the infrared-ray transmissible wavelength selecting element 210. However, any member may be used insofar as it allows infrared ray having a specific wavelength out of infrared rays emitted from the infrared ray source 200 to be incident to the infrared sensor 100.

Furthermore, the infrared ray transmissible wavelength selecting element 210 is disposed on the cap 220. However, the disposing position of the infrared ray transmissible wavelength selecting member 210 is not particularly limited to the above position insofar as it is on or above the infrared ray source 200 at a confronting side thereof to the infrared sensor 100 (or the side at which the infrared rays are emitted). For example, it may be formed on the surface of the infrared ray source 200.

### Third Embodiment

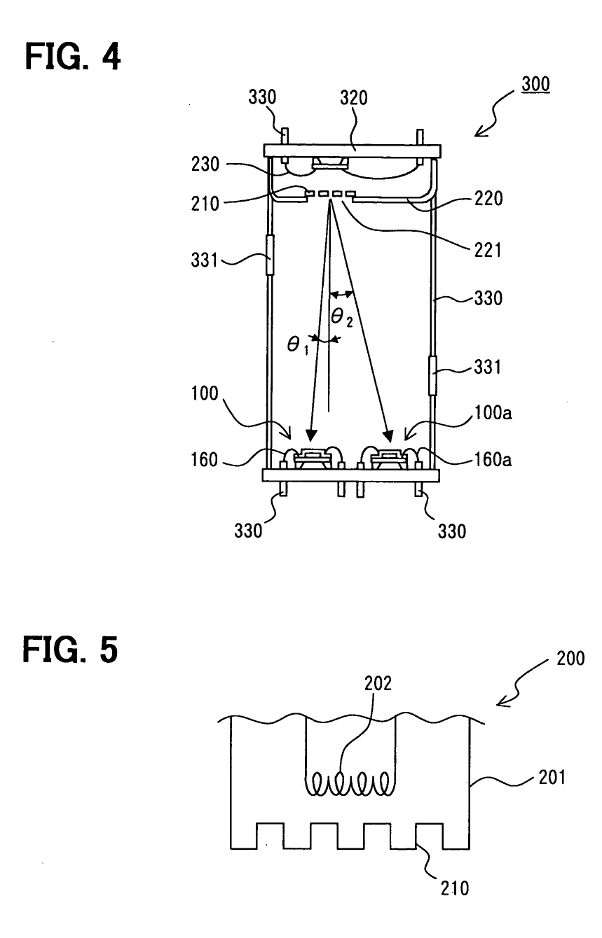

Next, a third embodiment will be described with reference to FIG. 4. FIG. 4 is a diagram showing the schematic construction of a gas sensor 300 according to this embodiment.

The gas sensor according to the third embodiment has many common parts to the infrared sensor 100 of the first embodiment and the gas sensor 300 of the second embodiment, and the detailed description on the common parts is omitted from the following description, and different parts will be mainly described.

As shown in FIG. 4, the gas sensor 300 of this embodiment has a reference infrared sensor 100a for absorbing infrared ray having a specific wavelength which is not overlapped with the infrared-ray absorption wavelength of the measurement target gas and outputting a reference signal corresponding to the absorption amount of the infrared ray, and further corrects the detection signal of the infrared sensor 100 on the basis of the reference signal.

The reference infrared sensor 100a is disposed in juxtaposition of the infrared sensor 100 on the table 320. It is designed in the same construction as the infrared sensor 100, and thus a can-sealing structure is not required. Accordingly, an infrared ray transmissible wavelength selecting element 210 is required to make infrared rays having specific wavelengths incident to the infrared sensor 100 and the reference infrared sensor 100a, respectively. Therefore, in this embodiment, a diffraction grating (multiple slit) is applied as the infrared-ray transmissible wavelength selecting element 210.

Here, the diffraction principle of the infrared rays in the diffraction grating will be described. When the wavelength of the plane wave of infrared ray incident to the diffraction grating is represented by λ , the grid interval of the diffraction grating is represented by P and the diffraction angle of the diffracted infrared ray with respect to the incident infrared ray is represented by θ, the following relationship is satisfied.
P sin θ=nλ (equation 1)

In the equation 1, n represents an integer value indicating a diffraction order. The infrared ray diffracted is weaker in intensity as the diffraction order is higher, and thus it is preferable to detect primary (n=±1) infrared ray in detection of the infrared ray. Here, n=0 means transmitted light.

As is apparent from the equation 1, when the grid interval P is fixed, the diffraction angle θ is varied in accordance with the wavelength λ of the infrared ray. That is, the diffraction angles θᵢ, θ₂ are different between the infrared ray having the specific wavelength detected by the infrared sensor 100 and the infrared ray having the specific wavelength detected by the reference infrared sensor 100a. Accordingly, as shown in FIG. 4, by arranging the infrared sensor 100 and the reference infrared sensor 100a in accordance with the respective detection wavelengths, the infrared sensor 100 and the reference infrared sensor 100a can detect the respective infrared rays with high precision.

In this embodiment, the diffraction grating (multiple slit) is applied as the infrared-ray transmissible wavelength selecting element 210. However, any member may be applied insofar as it can make the infrared rays having the specific wavelengths incident to the infrared sensor 100 and the reference infrared sensor 100a, respectively. For example, a plurality of band pass filters shown in the second embodiment may be laminated to transmit therethrough the infrared rays having the specific wavelengths to the infrared sensor 100 and the reference infrared sensor 100a.

Furthermore, in this embodiment, the diffraction grating is disposed as the infrared-ray transmissible wavelength selecting element 210 in the cap 220. However, the locating position of the infrared-ray transmissible wavelength selecting element 210 is not limited to a specific one insofar as it is disposed on or above the infrared ray source 200 at the infrared-ray emission side. For example, when the infrared ray source 200 is designed so as to emit infrared rays by supplying current to a filament 202 disposed in a valve 201, an uneven portion of a radiation wavelength order may be provided on a surface of the valve 201 which confronts the infrared sensor 100, thereby forming the infrared-ray transmissible wavelength selecting element 210.

Still furthermore, in this embodiment, the reference infrared sensor 100a and the infrared sensor 100 are separately provided in the same space comprising the container 310 and the tables 320. However, the infrared sensor 100 and the reference infrared sensor 100a may be formed by using the same substrate. Furthermore, the infrared sensor 100 and the reference infrared sensor 100a are disposed in the same space comprising the container 310 and the tables 320, however, they may be disposed in difference spaces.

### Fourth Embodiment

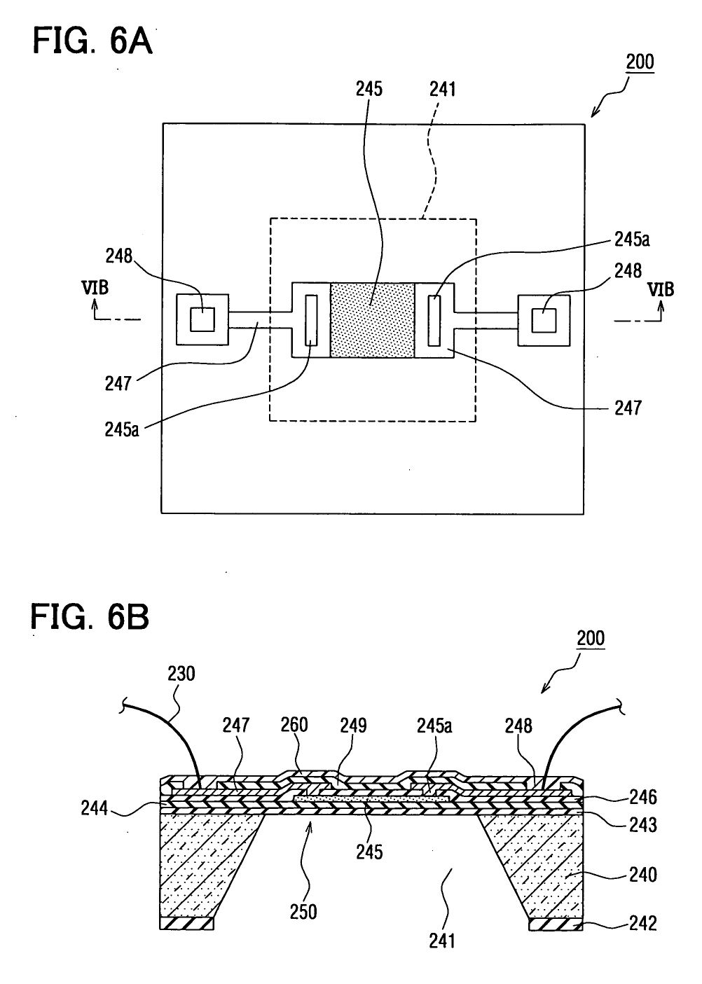

A fourth embodiment will be described with reference to FIGS. 6A and 6B. FIGS. 6A and 6B are diagrams showing the schematic construction of an infrared ray source 200 according to this embodiment, wherein FIG. 6A is a plan view and FIG. 6B is a cross-sectional view taken along VIB-VIB of FIG. 6A. In FIG. 6A, a resistor and a wire portion for connecting the resistor and electrodes are illustrated for the sake of convenience. In FIG. 6A, a rectangular area surrounded by a broken line represents a formation area of the upper surface of a cavity portion on the upper surface of the substrate.

The infrared ray source 200 of the fourth embodiment has many common parts to the infrared sensor 100 of the first embodiment. Therefore, the detailed description on the common parts is omitted from the following description, and the different parts will be mainly described hereunder.

As shown in FIG. 6B, the infrared ray source 200 comprises a substrate 240, a membrane 250 that is provided to the substrate 240 and serves as a small-thickness portion containing a resistor, and a second protection film 260 that is provided on the surface of the substrate 240 and formed of parylene. The second protection film 260 is a feature portion of this embodiment, and it corresponds to protection film of the present invention.

The substrate 240 is a semiconductor substrate of silicon, and has a cavity portion 241 corresponding to the formation area of the membrane 250. In this embodiment, the cavity portion 241 is opened so as to have a rectangular area, and the area of the opening portion is reduced toward the upper surface side of the substrate 240. A rectangular area (the upper surface of the cavity portion) as indicated by a broken line of FIG. 6A is formed at the upper surface of the substrate 240. Accordingly, the membrane 250 containing the resistor is formed while floated above the cavity portion 241 with respect to the substrate 240, and the film thickness of this site is smaller than the other sites of the infrared ray source 200. That is, it is thermally separated from the substrate 240, and thus the resistor can be efficiently heated to radiate infrared rays.

Silicon nitride film 242 is provided on the lower surface of the substrate 240, and insulating film 243 (for example, silicon nitride film) is provided on the upper surface of the substrate 240. Furthermore, silicon oxide film 244 is provided on the insulating film 243.

A resistor 245 formed of polycrystalline silicon film is provided in the formation area of the membrane 250 on the silicon oxide film 244 so as to have a predetermined shape. A wire portion 247 for electrically connecting the resistor 245 and electrodes is connected to the resistor 245 through interlayer insulating film 246 formed of BPSG. In FIGS. 6A and 6B, reference numeral 245a represents a connection portion between the resistor 245 and the wire portion 247, and in FIG. 6A, the resistor 245 is illustrated as being hatched to discriminate the resistor 245 from the other parts.

The wire portion 247 formed of aluminum has pad portions 248 as electrodes at both the end portions thereof, and first protection film 249 formed of silicon nitride is provided on the wire portion 247 excluding the pad portions 248.

Furthermore, under the state that bonding wires 230 are connected to the pad portions 248, second protection film 260 formed of parylene is provided on the whole surface at one surface side of the substrate 240 containing the pad portions 248.

With the above construction, the can-sealing structure is not required, so that the body can be miniaturized and the construction can be simplified. Furthermore, the energy amount of infrared rays transmitted through the second protection film 260 is larger than when gel is applied as the second protection film 260, and thus the light receiving efficiency of the infrared sensor 100 can be enhanced.

In the parylene group, parylene C is particularly excellent in the penetration preventing performance of water vapor and various kinds of gas. Accordingly, by applying parylene C as the second protection film 260, corrosion of the pad portions 248 can be more effectively prevented.

The resistor 245 is designed to be thermally separated from the substrate 240, so that the infrared ray source 200 can efficiently emit infrared rays and thus the sensor output of the infrared sensor 100 can be increased.

The infrared ray source 200 thus constructed can be formed by the same method as the method of forming the infrared sensor 100 of the first embodiment (however, the infrared-ray absorption film 140 is not formed, and the resistor 245 is formed in place of the polycrystalline silicon film 115). Accordingly, the substrate 240 having the membrane 250 can be easily manufactured by the general semiconductor process, so that the construction can be simplified and the infrared ray source 200 excellent in infrared ray emission efficiency can be manufactured at low cost.

In this embodiment, the first protection film 249 is formed on the interlayer insulating film 246 containing the wire portion 247 to protect the wire portion 247 formed of aluminum. However, since parylene excellent in the water-vapor penetration preventing performance is provided as the second protection film 260 on the whole surface at one surface side of the substrate 240 containing the pad portions 248, and thus the first protection film 249 is not necessarily required to be formed.

Furthermore, the infrared ray source 200 thus constructed in this embodiment is applicable to the gas sensors 300 of the second and third embodiments. In this case, the cap 220 at the infrared ray source 200 side is not required, and thus the construction of the gas sensor 300 can be simplified. Furthermore, the body of the sensor can be miniaturized. The infrared-ray transmissible wavelength selecting element 210 may be formed on the surface of the infrared ray source 200 (for example, on the second protection film 260).

The above embodiments are preferable embodiments of the present invention. However, the present invention is not limited to the above embodiments, and various modifications may be made.

Furthermore, in this embodiment, the semiconductor substrate formed of silicon is used as the substrates 110, 240 constituting the infrared sensor 100 and the infrared ray source 200. However, the substrates 110, 240 are not limited to the semiconductor substrate, and other type substrates such as a glass substrate, may be applied as the substrates 110, 240.

What is claimed is:

1. An infrared sensor comprising:
a substrate;
a membrane as a small-thickness portion formed on the substrate;
a detecting element for generating a detection signal on the basis of temperature variation occurring when receiving infrared rays, at least a part thereof being formed on the membrane; and
infrared ray absorption film formed on the membrane so as to cover at least a part of the detecting element, wherein under the state that the detecting element is electrically connected to the outside through a sensor pad portion provided to the end portion of the detecting element, a substrate surface containing the sensor pad portion and the infrared ray absorption film is coated by protection film formed of parylene.

2. The infrared sensor according to claim 1, wherein the detecting element comprises a thermocouple having a hot contact point formed on the membrane and a cold contact point formed on the substrate excluding the formation area of the membrane.

3. The infrared sensor according to claim 1, wherein the substrate is a semiconductor substrate and the detecting element is formed on the semiconductor substrate through insulating film.

4. The infrared sensor according to claim 1, wherein the protection film is formed of parylene C.

5. An infrared ray detecting type gas detector for detecting the concentration of measurement target gas including:
an infrared sensor comprising a substrate, a membrane as a small-thickness portion formed on the substrate, a detecting element for generating a detection signal on the basis of temperature variation occurring when receiving infrared rays, at least a part thereof being formed on the membrane, and infrared ray absorption film formed on the membrane so as to cover at least a part of the detecting element, wherein under the state that the detecting element is electrically connected to the outside through a sensor pad portion provided to the end portion of the detecting element, a substrate surface containing the sensor pad portion and the infrared ray absorption film is coated by protection film formed of parylene;
an infrared ray source for emitting infrared rays to the infrared sensor by heating a resistor, the infrared sensor and the infrared ray source being mounted in the same package; and
an infrared-ray transmissible wavelength selecting element that is disposed on or above the infrared ray source and make infrared ray having a specific wavelength incident to the infrared ray source.

6. The infrared ray detecting type gas detector according to claim 5, further comprising a reference infrared sensor for absorbing infrared ray having a specific wavelength non-overlapped with the infrared-ray absorption wavelength of the measurement target gas and outputting a reference signal in accordance with the infrared-ray absorption amount, wherein the infrared-ray transmissible wavelength selecting element makes infrared rays having specific wavelengths incident to the infrared sensor and the reference infrared sensor, respectively.

7. The infrared ray detecting type gas detector according to claim 6, wherein the infrared-ray transmissible wavelength selecting element is a diffraction grating.

8. An infrared ray source for irradiating infrared rays to an infrared sensor comprising:
a substrate;
a membrane as a small-thickness portion provided to the substrate; and
a resistor provided to the membrane, the resistor being heated by supplying current to the resistor to detect the infrared rays, wherein under the state that the resistor is electrically connected to the outside through an infrared ray source pad portion provided to the end portion of the resistor, the substrate surface containing the infrared ray source pad portion is coated by protection film formed of parylene.

9. The infrared ray source according to claim 8, wherein the substrate is a semiconductor substrate, and the resistor is formed on the semiconductor substrate through insulating film.

10. The infrared ray source according to claim 8, wherein the protection film is formed of parylene C.
